(19) United States
(12) Patent Application Publication
(10) Pub. No.: US 2007/0297875 A1
(43) Pub. Date: Dec. 27, 2007

(54) Multi purpose trailer

(76) Inventors: J. David Girtman, Vaughn, MT (US); Jim C. Helfrich, Sun River, MT (US)

Correspondence Address: Jim C. Helfrich, 200 Choteau ST, Sun River, MT, 59483, US

(21) Appl. No.: 11/475,353

(22) Filed: Jun. 27, 2006

(51) Int. Cl. A01D 85/00

(52) U.S. Cl. 414/24.5

(57) ABSTRACT

A trailer for handling large round bales by loading and unloading them without the requirement of additional equipment or hydraulics as well as transporting one or more bales at a time. In addition the bale loading, hauling and unloading portions of the trailer may be replaced with other hauling structures such as hoppers, flat beds and RTV carriers to mention just a few.

### FIELD OF THE INVENTION

The present invention relates to a multi purpose trailer and, more particularly, to a trailer that will load and unload large round bales without the aid of a tractor or hydraulics as well as other cargos.

### BACKGROUND OF THE INVENTION

Large round forage bales weigh as much as 2,000 pounds each and are difficult to load and transport unless a tractor or some other large mechanical device with hydraulics is present to load and unload. With the growing number of hobby farmers and the availability of small bales becoming less it has increased the difficulty of the hobby farmer to obtain and feed his or her animals. Tractors are expensive to purchase and maintain. They are often diesel and forethought is required in cold weather to start them. In addition they are unsafe and impractical for hauling bales for long distances as well as expensive in fuel consumption to do so.

The hobby farmer has long needed a means to enable him to purchase large bales, transport them home in a safe efficient manner, store them and then be able to reload them for transportation to the feeder where they can be unloaded without the need of hydraulics or other large equipment.

Further, none of these trailers can be used for other purposes when large round bales are not being hauled. This is an economic expense that forces the hobby farmer to own multiple trailers to perform different tasks; thus increasing cost, maintenance and storage problems.

Many other solutions exist but they are all centered around the large professional farmer or need for hydraulics and other large equipment such as Danner Des. 331,413 with its design of a large trailer to haul square bales. This design provides no means for loading and unloading large round bales. Hynson in U.S. Pat. No. 3,958,772 shows a device that will attach to the three point hitch of a tractor, lift and weigh it so it can be loaded onto a trailer, thus requiring a tractor, hydraulics and a separate trailer to haul and unload with. Kannady in U.S. Pat. No. 3,985,253 demonstrates a round bale carrier that will load and unload one round bale in a horizontal position only. Hauling only one bale at a time increases the cost of transportation substantially. By unloading the bale in a horizontal position it makes it difficult to place the bale into a round feeder for livestock and the trailer cannot be used for any other purpose other than to haul one round bale.

Van Antwerp in U.S. Pat. No. 4,179,034 offers a method to spear a large bale and to elevate it. This bale loader offers the hauler the ability to carry one bale, principally unsupported from the bottom increasing the chance that portions of the bale will fall off on the road, especially when hauled for long distances. It permits the bale to be hauled and unloaded only in the horizontal position. It requires a tractor or a pickup truck of substantial size. This device is designed for on-farm moving.

Doan in U.S. Pat. No. 4,930,964 shows an invention that will self-load a large round bale and then another and another until there are 4 in total. It unloads by dumping them to the side. This hauler is designed for the larger farmer and to remove bales from the field rather than a stack where the hobby farmer will often be retrieving bales from.

Shonka shows in U.S. Pat. No. 5,165,836 a large capacity round bale retriever and hauler that requires tractor operation. While in prior art presented by Siebenga in U.S. Pat. No. 5,211,345 a loading, hauling and stacking trailer for handling large round balers is displayed which requires a tractor to operate.

Willis in U.S. Pat. No. 5,236,294 displays a bale hauler and loader. Clay, Sr., shows a lifter/hauler that uses a ratchet to raise and lower one bale at a time on the rear of a truck in U.S. Pat. No. 5,603,597. Willis in U.S. Pat. No. 5,630,689 has a bale loader and transport that requires the use of a tractor to operate. Connell, Jr. in U.S. Pat. No. 5,639,199 demonstrates a self propelled large round bale retriever and hauler.

Quirk in U.S. Pat. No. 5,647,038 uses a side by side large round bale carrying only device that will mount to a truck for the purpose of hauling and then the bales may be unloaded by dumping them. Bingham in U.S. Pat. No. 5,676,513 shows a trailer that is ground driven that will load and carry multiple large round bales. This unit is deigned to retrieve bales from the field rather than from a stack. Eiland demonstrates in a U.S. Pat. No. 5,919,021 a means for loading multiple large round bales on a gooseneck trailer in the field which requires a motor to raise and lower the trailer. All of the bales are unloaded in the horizontal position. Ellis displays in U.S. Pat. No. 6,811,367 B2 a bale loading and hauling device that is hydraulically operated.

The other solutions discussed do not meet the needs of the hobby farmer. They are designed to fill the needs of the professional or large farmer. Most require a tractor or at least hydraulics which require a sophisticated and dedicated device for loading, hauling, and unloading bales. None of them provide for multiple use of the devices. So any hobby farmer is saddled with the problems that he so wants to solve. He cannot economically, efficiently or practically purchase, load, haul and unload a bale into a feeder for his livestock. Further he cannot use the trailer for any other purpose thus increasing his purchase cost, maintenance cost, shelter cost or the difficulty in trying to use multiple trailers with multiple connections to service his needs.

It is therefore an object of the invention to load and unload large round bales without the need for other equipment or hydraulics.

It is another object of the invention to transport one or more large round bales.

It is another object of the invention to transport and stack small square bales without further handling.

It is another object of the invention to transport and spread or dump from a hopper various materials.

It is another object of the invention to transport RTV's, ATV's and Snow machines.

It is another object of the invention to provide for a tilt deck flatbed trailer option.

It is another object of the invention to provide a multi use trailer for towing behind any type vehicle capable of such loads.

It is another object of the invention to reduce the cost to the owner of owning multiple trailers.

It is another object of the invention to reduce the transportation cost of hauling various cargos.

It is another object of the invention to reduce the problems associated with owning multiple trailers.

### SUMMARY OF THE INVENTION

In accordance with the present invention, there is provided a trailer for handling large round bales by loading and unloading them without the requirement of additional equipment or hydraulics as well as transporting one or more bales at a time. In addition the bale loading, hauling and unloading portions of the trailer may be replaced with other hauling structures such as hoppers, flat beds and RTV carriers to mention just a few.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a carrier frame;

FIG. 2 is a perspective view of a carrier frame fitted with a side basket;

FIG. 3 is a perspective view of a main carrier fitted with large bale baskets;

FIG. 4 is a schematic & perspective view of a side basket frame and wire base;

FIG. 5 is a schematic & perspective view of a rear basket;

FIG. 6 is a side elevation view of an optional tilt bed trailer mount;

FIG. 7 is a perspective view of an optional hopper attachment; and

FIG. 8 is a perspective view of an optional box drag attachment.

For purposes of clarity and brevity, like elements and components will bear the same designations and numbering throughout the Figures.

### DESCRIPTION OF THE PREFERRED EMBODIMENT

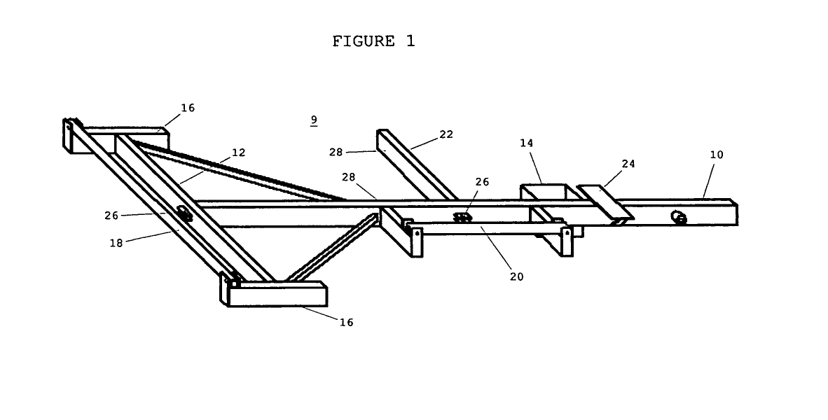

FIG. 1 is a perspective view of a carrier frame.

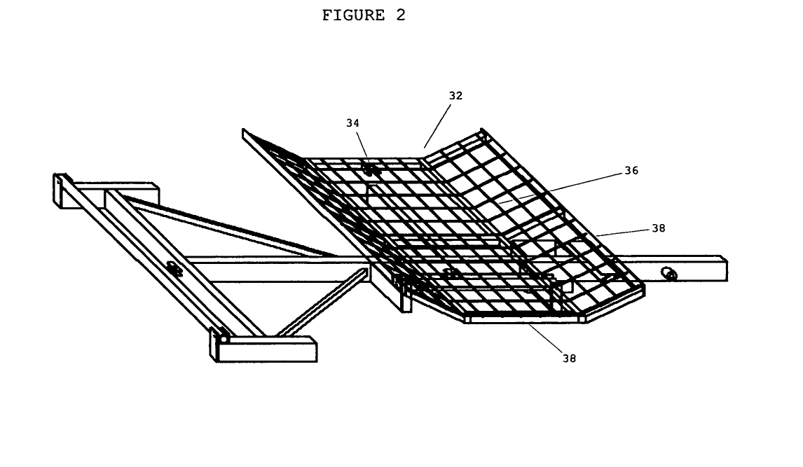

FIG. 2 is a perspective view of a carrier frame fitted with a side basket 32.

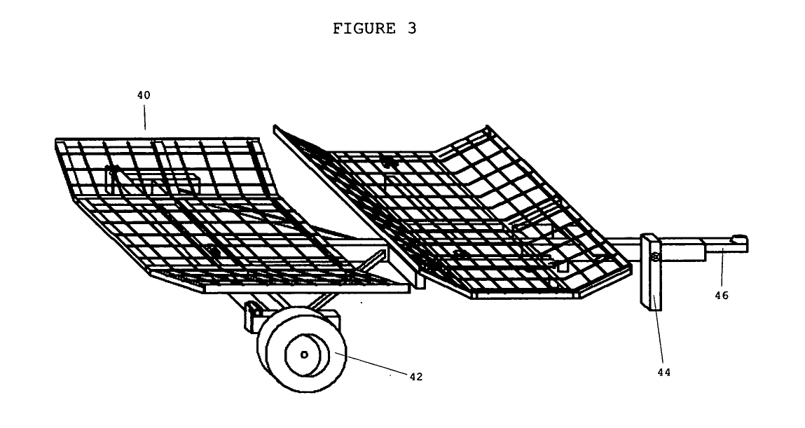

FIG. 3 is a perspective view of a main carrier fitted with large bale baskets.

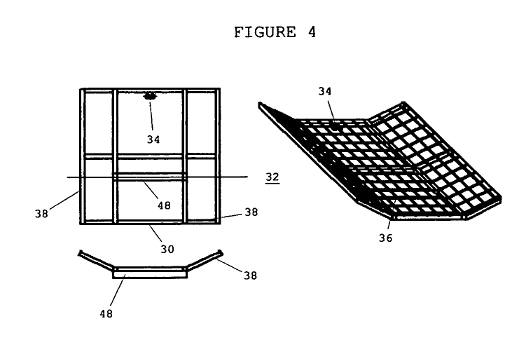

FIG. 4 is a schematic & perspective view of a side basket frame 38 and wire base 36.

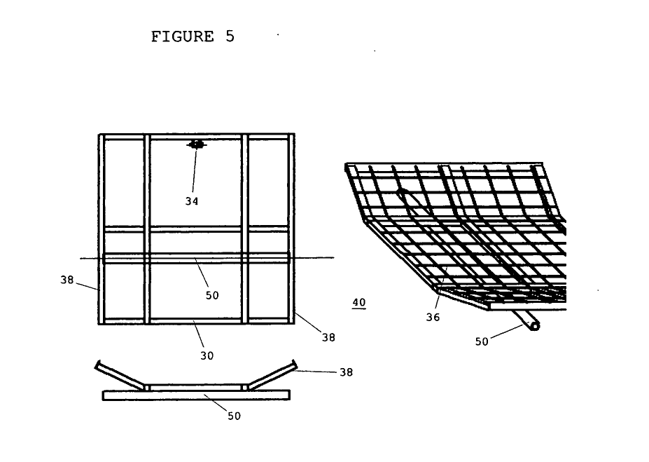

FIG. 5 is a schematic & perspective view of a rear basket 40.

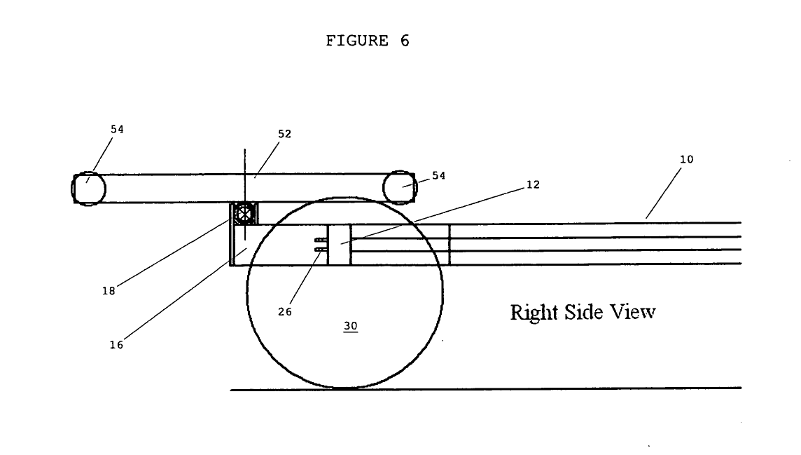

FIG. 6 is a side elevation view of an optional tilt bed trailer mount.

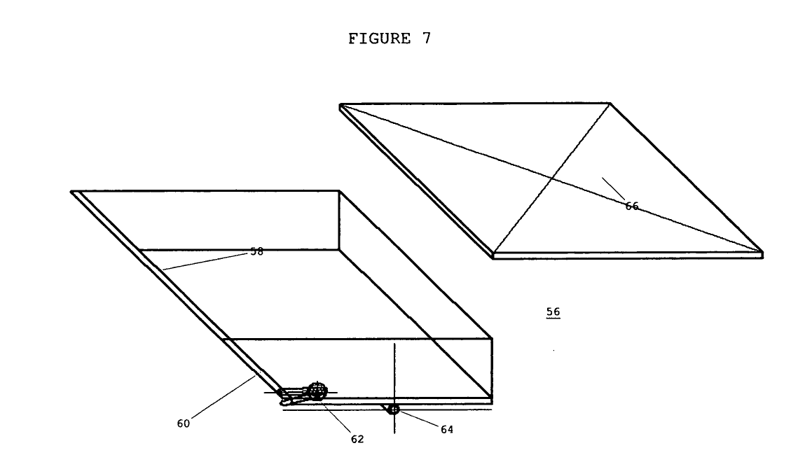

FIG. 7 is a perspective view of an optional hopper 56 attachment.

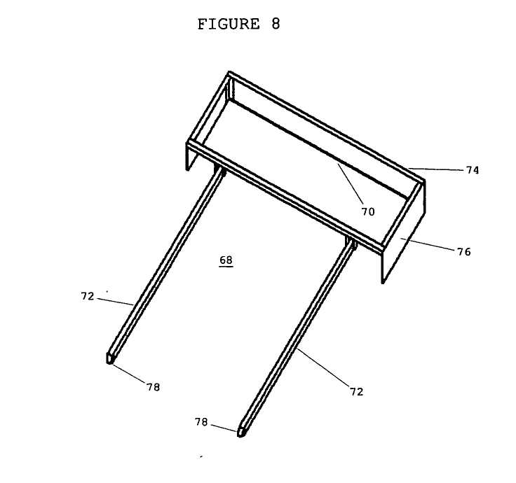

FIG. 8 is a perspective view of an optional box drag attachment.

Referring to FIG. 1 there is a carrier frame means 9 consisting of a main beam 10 of this invention attached to a rear cross beam 12 which axle mounts 16 are fitted to secure at least one axle. It comprises a carrier frame indicated generally FIG. 1. The trailer frame is indicated generally and comprises essentially a rectangular frame having one main beam 10 and one rear cross beam 12 and two axle mounts 16 where axles are fitted (not shown). A winch mount 24, battery box 14, side attachment anchor beam 22, spring mount 26, rear attachment pivot 18 and a side attachment pivot 20 are indicated. The description of side and rear are derived from the fact of the direction in which the vehicle normally travels. The carrier frame means 9 includes a rigid main beam 10 support, by means of which the carrier frame means 9 is supported on an axle (not shown) which is parallel to the rear cross beam 12 frame members. Wheels (not shown) are provided and supported on the axle by conventional means. These wheels can have a brake mechanism which can be electrical, mechanical or hydraulic as desired, so that during a selected time interval the brakes can be locked to prevent the wheels from turning. The battery box 14 can hold a battery to power at least one electric winch. The winch mount 24 can be fitted with at one or more winches for operation of the pivot attachments. A cable anchor point 28 is provided for the end of each winch cable for use when multiplication of winch power is wanted.

Referring to FIG. 2 there is a carrier frame means 9 as described in FIG. 1 shown with a side basket 32 consisting of a basket frame 38, wire base 36 and cable pulley 34 attachment. The basket frame 38 means is composed of rigid lateral beams parallel to each other with rigid cross beams that are perpendicular to the lateral beams but parallel to each other covered with a heavy wire material to prevent objects from falling through the side basket 32. A pivot tube is attached below the side basket frame 38 to permit the side basket 32 to pivot from a horizontal position to a vertical position and back. The cable pulley 34 means permits the cable to be looped through the cable pulley 34 for multiplication of pulling effect by the winch or directly for less multiplication but faster retrieval of the side basket 32 into the horizontal position.

Referring to FIG. 3 there is a carrier frame means 9 as described in FIG. 1 and FIG. 2 shown with a side and rear basket 40 consisting of a basket frame 38, wire base 36 and cable pulley 34 attachment. The basket frame 38 means is composed of rigid lateral beams parallel to each other with rigid cross beams that are perpendicular to the lateral beams but parallel to each other covered with a heavy wire material to prevent objects from falling through the side or rear basket 40. A pivot tube is attached below the side basket 32 and rear basket frame 38 to permit the side basket 32 or rear basket 40 to pivot independently from a horizontal position to a vertical position and back. The cable pulley 34 means permits the cable to be looped through the cable pulley 34 for multiplication of pulling effect by the winch or directly for less multiplication but faster retrieval of the side basket 32 or rear basket 40 independently into the horizontal position.

FIG. 3 further displays the position of the wheel 42, jack 44 and hitch 46 as they are attached to the carrier frame means 9.

Referring to FIG. 4 the side basket frame 38 means is composed of rigid lateral beams parallel to each other with rigid cross beams that are perpendicular to the lateral beams but parallel to each other covered with a heavy base wire material to prevent objects from falling through the side basket 32. A side basket pivot tube 48 is attached below the side basket 32 to permit the side basket 32 or rear basket 40 to pivot independently from a horizontal position to a vertical position and back. The cable pulley 34 means permits the cable to be looped through the cable pulley 34 for multiplication of pulling effect by the winch or directly for less multiplication but faster retrieval of the side basket 32 or rear basket 40 independently into the horizontal position. A tension spring j bolt 30 is attached to the lower side basket frame 38 for attachment of an extension spring to provide tension on the side basket 32. This tension spring facilitates the unassisted manual lifting of the side basket 32 and prevents the side basket 32 from dropping uncontrollably as it is lowered can comes over center in its decent from a vertical position to a horizontal position.

Referring to FIG. 5 the rear basket frame 38 means is composed of rigid lateral beams parallel to each other with rigid cross beams that are perpendicular to the lateral beams but parallel to each other covered with a heavy base wire material to prevent objects from falling through the rear basket 40. A rear basket pivot tube 50 is attached below the rear basket 40 to permit the rear basket 40 to pivot independently from a horizontal position to a vertical position and back. The cable pulley 34 means permits the cable to be looped through the cable pulley 34 for multiplication of pulling effect by the winch or directly for less multiplication but faster retrieval of the rear basket 40 or rear basket 40 independently into the horizontal position. A tension spring j bolt 30 is attached to the lower rear basket frame 38 for attachment of an extension spring to provide tension on the rear basket 40. This tension spring facilitates the unassisted manual lifting of the rear basket 40 and prevents the rear basket 40 from dropping uncontrollably as it is lowered and comes over center in its decent from a vertical position to a horizontal position.

Referring to FIG. 6 one of the several optional attachments, in particular to accommodate a tilting flat bed trailer attachment. The rear attachment pivot 18 is removable and replaceable permitting the main carrier frame to facilitate the attachment of various optional attachments. In FIG. 6 the rear attachment tilt trailer pivot 52 means is composed of rigid lateral beams parallel to each other with rigid cross beams that are perpendicular to the lateral beams but parallel to each other fitted with axle rollers 54. These axle rollers 54 intercept and operate in a tract fitted to the undercarriage of the flat bed top. This fitting permits the axle rollers 54 to travel inside a rigid c beam of the flat bed undercarriage permitting the flat bed to transverse its center resting position on the carrier frame means 9 causing it to tip from a horizontal position to one in which contact with the ground to the rear of the carrier frame means 9 is situated. In this rear position the flat bed can be easily accessed by wheeled or tracked vehicles for loading and off loading. When the vehicle is loaded the flat bed can be moved to its forward loaded transportation position by means of a winch located on the winch mount 24.

Referring to FIG. 7 a hopper 56, one of the several optional attachments. In particular a generally rectangular structure consisting of two sides, a front, a rear angled swing gate 60 with an adjustable lower opening, a bottom and a means for adjusting the rear swing gate's relative opening. The hopper 56 is made from a rigid material and is fitted with a rear swing gate 60 that in its fully closed position is generally angled between 30 and 60 degrees facilitating a rock and trash dump end 58. The rear swing gate 60 is fitted with a controllable opening device, swing gate adjustment 62, which permits incremental opening of the rear swing gate 60 to facilitate accurate opening distances. A hopper pivot tube 64 is attached to the lower carriage of the hopper 56 permitting the hopper 56 to pivot on the rear attachment pivot 18. Pivoting of the hopper 56 from its resting or horizontal position to an elevated or vertical position facilitates the emptying of the hopper 56 such is in releasing sand, gravel or other aggregate in a spreading action determined by the position of the open rear swing gate 60. Or to empty the hopper 56 with the rear swing gate 60 closed when larger objects are contained in the hopper 56 and the desire is simply to remove them. An optional hopper lid 66 is depicted and consists of a rigid generally flat top portion with four rigid side portions at a generally 90 degree angle to the top portion.

Referring to FIG. 8 a box drag, one of the several optional attachments. In particular a generally rectangular structure consisting of two box grader sides 76, a rear fitted with a hardened grader blade 70 to the box grader frame 74 with an adjustable lower opening, and a means for attaching the box grader 68 to the rear pivot attachment of the main carrier means, arms. The box scraper is made from a rigid material an arm pivot tube 78 is attached to one end of each arm 72 to connect the box drag to the main carrier frame so that the box drag follows in close proximity to the hopper 56 as it spreads its contents. The box drag then spreads and fills as it follows creating an even smooth surface behind the hopper 56.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A multi purpose trailer for the hauling and loading of various cargos such as large round hay bales, the hauling and spreading of aggregates, hauling and stacking of small hay bales, loading and hauling of off road recreational machines, and other various cargos, comprising:
means for supporting and carrying the attachments connected to it, being towed by another motorized vehicle;
means for pivoting of the various attachments. it provides an anchor and pivot point that permits operation of the hay baskets and hoppers as well as a location to place the tilt trailer pivot axle;
means for pivoting of the various attachments. it provides a secure location for the operation of attachments that must pivot as part of their function;
means for securing the pivoting attachment in the lowered position and preventing the attachment from unnecessary movement in the vertical direction during transit;
means for securing the winch to the trailer;
means for attachment of the tension spring to the trailer;
means for providing and anchor point for one end of the cable used in operating the pivoting attachments;
means for securing the tension spring to the pivoting attachment;
means for loading, carrying and unloading large round bales, the side basket serves as a platform in which to secure the bale to this bale then can be raised into the transport or generally horizontal position for transport after which it may be lowered to the ground for feeding;
means for loading, carrying and unloading of large round bales, the rear basket serves as a platform to secure the large bale to, raise the bale into a transport position that is generally horizontal and then permit the hauler to lower the bale back to the ground, removably connected to said means for securing the tension spring to the pivoting attachment;
means for permitting the side basket to pivot around the side attachment axle;
means for permitting the rear basket pivot about the rear attachment axle, rigidly welded to said means for loading, carrying and unloading of large round bales, the rear basket serves as a platform to secure the large bale to, raise the bale into a transport position that is generally horizontal and then permit the hauler to lower the bale back to the ground; and
means for permitting the box grader arm to pivot on the trailers rear pivot.

2. The multi purpose trailer in accordance with claim 1, wherein said means for supporting and carrying the attachments connected to it, being towed by another motorized vehicle comprises a rigid, strong, tram carrier frame means.

3. The multi purpose trailer in accordance with claim 1, wherein said means for pivoting of the various attachments. it provides an anchor and pivot point that permits operation of the hay baskets and hoppers as well as a location to place the tilt trailer pivot axle comprises a pivatol, removable, cylindrical, nonflexible, securable rear attachment pivot.

4. The multi purpose trailer in accordance with claim 1, wherein said means for pivoting of the various attachments. it provides a secure location for the operation of attachments that must pivot as part of their function comprises a pivitatol, securable, removable, cylindrical, nonflexible side attachment pivot.

5. The multi purpose trailer in accordance with claim 1, wherein said means for securing the pivoting attachment in the lowered position and preventing the attachment from unnecessary movement in the vertical direction during transit comprises a nonflexible, weldably attached side attachment anchor beam.

6. The multi purpose trailer in accordance with claim 1, wherein said means for securing the winch to the trailer comprises a generally flat plate, stiff, weldably fastened, holed winch mount.

7. The multi purpose trailer in accordance with claim 1, wherein said means for attachment of the tension spring to the trailer comprises a stiff, generally flat, holed spring mount.

8. The multi purpose trailer in accordance with claim 1, wherein said means for providing and anchor point for one end of the cable used in operating the pivoting attachments comprises a cylindrical, stiff cable anchor point.

9. The multi purpose trailer in accordance with claim 1, wherein said means for securing the tension spring to the pivoting attachment comprises an attachably removable, j shaped tension spring j bolt.

10. The multi purpose trailer in accordance with claim 1, wherein said means for loading, carrying and unloading large round bales, the side basket serves as a platform in which to secure the bale to this bale then can be raised into the transport or generally horizontal position for transport after which it may be lowered to the ground for feeding comprises a generally concave, pivotal, generally open, securable side basket.

11. The multi purpose trailer in accordance with claim 1, wherein said means for loading, carrying and unloading of large round bales, the rear basket serves as a platform to secure the large bale to, raise the bale into a transport position that is generally horizontal and then permit the hauler to lower the bale back to the ground comprises a generally concave, generally open, pivotal, securable rear basket.

12. The multi purpose trailer in accordance with claim 1, wherein said means for permitting the side basket to pivot around the side attachment axle comprises a generally tubular, pivotal side basket pivot tube.

13. The multi purpose trailer in accordance with claim 1, wherein said means for permitting the rear basket pivot about the rear attachment axle comprises a generally tubular, pivotal rear basket pivot tube.

14. The multi purpose trailer in accordance with claim 1, wherein said means for permitting the box grader arm to pivot on the trailers rear pivot comprises a tubular, weldably attached arm pivot tube.

15. A multi purpose trailer for the hauling and loading of various cargos such as large round hay bales, the hauling and spreading of aggregates, hauling and stacking of small hay bales, loading and hauling of off road recreational machines, and other various cargos, comprising:
a rigid, strong, tram carrier frame means, for supporting and carrying the attachments connected to it, being towed by another motorized vehicle;
a pivatol, removable, cylindrical, nonflexible, securable rear attachment pivot, for pivoting of the various attachments. it provides an anchor and pivot point that permits operation of the hay baskets and hoppers as well as a location to place the tilt trailer pivot axle;
a pivitatol, securable, removable, cylindrical, nonflexible side attachment pivot, for pivoting of the various attachments. it provides a secure location for the operation of attachments that must pivot as part of their function;
a nonflexible, weldably attached side attachment anchor beam, for securing the pivoting attachment in the lowered position and preventing the attachment from unnecessary movement in the vertical direction during transit;
a generally flat plate, stiff, weldably fastened, holed winch mount, for securing the winch to the trailer;
a stiff, generally flat, holed spring mount, for attachment of the tension spring to the trailer;
a cylindrical, stiff cable anchor point, for providing and anchor point for one end of the cable used in operating the pivoting attachments;
an attachably removable, j shaped tension spring j bolt, for securing the tension spring to the pivoting attachment;
a generally concave, pivotal, generally open, securable side basket, for loading, carrying and unloading large round bales, the side basket serves as a platform in which to secure the bale to this bale then can be raised into the transport or generally horizontal position for transport after which it may be lowered to the ground for feeding;
a generally concave, generally open, pivotal, securable rear basket, for loading, carrying and unloading of large round bales, the rear basket serves as a platform to secure the large bale to, raise the bale into a transport position that is generally horizontal and then permit the hauler to lower the bale back to the ground, removably connected to said tension spring j bolt;
a generally tubular, pivotal side basket pivot tube, for permitting the side basket to pivot around the side attachment axle;
a generally tubular, pivotal rear basket pivot tube, for permitting the rear basket pivot about the rear attachment axle, rigidly welded to said rear basket; and
a tubular, weldably attached arm pivot tube, for permitting the box grader arm to pivot on the trailers rear pivot.

16. A multi purpose trailer for the hauling and loading of various cargos such as large round hay bales, the hauling and spreading of aggregates, hauling and stacking of small hay bales, loading and hauling of off road recreational machines, and other various cargos, comprising:
a rigid, strong, tram carrier frame means, for supporting and carrying the attachments connected to it, being towed by another motorized vehicle;
a pivatol, removable, cylindrical, nonflexible, securable rear attachment pivot, for pivoting of the various attachments, it provides an anchor and pivot point that permits operation of the hay baskets and hoppers as well as a location to place the tilt trailer pivot axle;
a pivitatol, securable, removable, cylindrical, nonflexible side attachment pivot, for pivoting of the various attachments, it provides a secure location for the operation of attachments that must pivot as part of their function;
a nonflexible, weldably attached side attachment anchor beam, for securing the pivoting attachment in the lowered position and preventing the attachment from unnecessary movement in the vertical direction during transit;
a generally flat plate, stiff, weldably fastened, holed winch mount, for securing the winch to the trailer;
a stiff, generally flat, holed spring mount, for attachment of the tension spring to the trailer;
a cylindrical, stiff cable anchor point, for providing and anchor point for one end of the cable used in operating the pivoting attachments;
an attachably removable, j shaped tension spring j bolt, for securing the tension spring to the pivoting attachment;
a generally concave, pivotal, generally open, securable side basket, for loading, carrying and unloading large round bales, the side basket serves as a platform in which to secure the bale to this bale then can be raised into the transport or generally horizontal position for transport after which it may be lowered to the ground for feeding;
a generally concave, generally open, pivotal, securable rear basket, for loading, carrying and unloading of large round bales, the rear basket serves as a platform to secure the large bale to, raise the bale into a transport position that is generally horizontal and then permit the hauler to lower the bale back to the ground, removably connected to said tension spring j bolt;
a generally tubular, pivotal side basket pivot tube, for permitting the side basket to pivot around the side attachment axle;
a generally tubular, pivotal rear basket pivot tube, for permitting the rear basket pivot about the rear attachment axle, rigidly welded to said rear basket; and
a tubular, weldably attached arm pivot tube, for permitting the box grader arm to pivot on the trailers rear pivot.
